(19) United States
(12) Patent Application Publication
(10) Pub. No.: US 2026/0356996 A1
(43) Pub. Date: Nov. 12, 2026

(54) METHOD FOR MANUFACTURING FUNCTIONAL POLYMERS BY ANIONIC POLYMERIZATION

(71) Applicants: ENF TECHNOLOGY CO., LTD., Yongin-si, Gyeonggi-do (KR); UBMATERIALS INC., Yongin-si, Gyeonggi-do (KR)

(72) Inventors: Jun-Ho LEE, Yongin-si, Gyeonggi-do (KR); Hee-Chun EUN, Yongin-si, Gyeonggi-do (KR); Jeong-Hwa KIM, Yongin-si, Gyeonggi-do (KR); Ji-Yun WANG, Yongin-si, Gyeonggi-do (KR)

(21) Appl. No.: 19/515,143

(22) PCT Filed: Sep. 2, 2024
(86) PCT No.: PCT/KR2024/013150

§ 371 Date: Feb. 27, 2026

(30) Foreign Application Priority Data
Aug. 31, 2023 (KR) 10-2023-0115619
Aug. 30, 2024 (KR) 10-2024-0118012

(51) Int. Cl. C08F 112/14; B01J 14/00; B01J 19/00; B01J 19/06

(52) U.S. Cl. CPC C08F 112/22; B01J 14/00; B01J 19/0093; B01J 19/06; B01J 2219/00891

(57) ABSTRACT

The present invention relates to a method for manufacturing functional polymers by anionic polymerization. The polymer manufacturing method according to the present invention can economically produce polymers having high chemical uniformity and enables an anionic polymerization reaction even at a relatively high temperature. The method comprises injecting a first solution containing one or more solvents selected from the group consisting of an ether-based solvent and a non-polar solvent and a monomer, and a second solution containing the solvent and an anionic polymerization initiator into a microfluidic reactor; and anionically polymerizing the monomer in the microfluidic reactor.

### CROSS REFERENCE TO RELATED APPLICATIONS

The present application is a U.S. National Phase of International Application No. PCT/KR2024/013150 entitled “METHOD FOR MANUFACTURING FUNCTIONAL POLYMERS BY ANIONIC POLYMERIZATION”, and filed on Sep. 2, 2024. International Application No. PCT/KR2024/013150 claims priority to Republic of Korea Patent Application No. 10-2023-0115619 filed on Aug. 31, 2023, and to Republic of Korea Patent Application No. 10-2024-0118012 filed on Aug. 30, 2024. The entire contents of each of the above-listed applications are hereby incorporated by reference for all purposes.

### TECHNICAL FIELD

The present invention relates to a method for manufacturing polymers by anionic polymerization using a microfluidic reactor.

### BACKGROUND ART

An anionic polymerization reaction may be easier to use to control a molecular weight by a molar ratio of an initiator and monomer due to the characteristics of a polymerization method as compared to other polymerization methods, and may also have the advantage of maintaining a narrow molecular weight polydispersity. Since anionic polymerization has the characteristics of living polymerization, there is no termination reaction unless a protic compound exists in a polymerization reaction system, and there is no termination reaction such as ion pair rearrangement. Accordingly, in the polymerization reaction system, a polymer chain has an active anion terminal and continues to grow according to an injection of the monomer.

The anionic polymerization reaction causes a side reaction due to the heat generated during the reaction, which reduces the uniformity of the polymer. Accordingly, the anionic polymerization reaction should be performed at a significantly low temperature in a polar solvent.

Additionally, since the anionic polymerization reaction proceeds immediately at an active polymer anion terminal after the injection of the monomer, when rapid and uniform mixing is not achieved in a reactor, there may be a problem in which the heterogeneity between the polymers inevitably increases, and the molecular weight polydispersity of the polymers manufactured increases.

As disclosed in Japanese Patent No. 7012866 entitled ‘Polymer Production Method and Flow-type Reaction System for Manufacturing Polymer,’ provided is a method of producing polymers by performing anionic polymerization reaction using a microflow-type reaction system.

The microflow-type reaction system has the advantage of easy control of fluid flow and uniform control of the residence time in the reactor, and specifically, the microflow-type reaction system may be easy to control heat generated or consumed by a chemical reaction, and may have an advantage over a batch reactor in terms of material transfer.

However, the anionic polymerization reaction through a conventional flow-type reaction system may still have the problem in which the molecular weight polydispersity of the polymer manufactured may still increase because an anionic polymerization initiator and a monomer react immediately before the anionic polymerization initiator and the monomer are sufficiently homogeneously mixed when the anionic polymerization initiator and the monomer are injected into the reactor.

Additionally, the anionic polymerization reaction through the conventional microfluidic reactor still requires a separate cooling facility because the polymerization reaction should be performed at a low temperature. However, since most of the anionic polymerization reaction proceeds rapidly in the early stage of the reaction, the heat due to a rapid exothermal reaction is not effectively removed, so that side reactions may easily occur, and accordingly, it may be significantly difficult to manufacture polymers having a target molecular weight and molecular weight polydispersity. In order to suppress this side reaction, the temperature of the reactor may be set to an extremely low temperature and operated, but this is significantly uneconomical, and maintenance of the cooling facility may also be difficult, which may make mass production practically difficult.

### DISCLOSURE OF INVENTION

### Technical Problem

An aspect of the present invention is to provide a method for economically manufacturing polymers having high chemical uniformity.

Additionally, an aspect of the present invention is to provide a method for manufacturing polymers, enabling an anion polymerization reaction even at a relatively high temperature as compared to the conventional art.

Furthermore, an aspect of the present invention is to provide a method for manufacturing polymers, which may continuously manufacture high-quality polymers through a microfluidic reactor.

Aspects of the present invention are not limited to the above description. Those of ordinary skill in the art to which the present invention pertains will have no difficulty in understanding an additional aspect of the present invention from overall contents of the present specification.

### Solution to Problem

A method for manufacturing polymers according to the present invention may include: (S1) an operation of injecting a first solution containing one or more solvents selected from the group consisting of an ether-based solvent and a non-polar solvent and a monomer, and a second solution containing the solvent and an anionic polymerization initiator into a microfluidic reactor; and (S2) an operation of anionically polymerizing the monomer in the microfluidic reactor, wherein the microfluidic reactor may include: a main body provided with at least one inlet hole through which the first solution and the second solution are introduced and an outlet hole through which a third solution containing polymers in which the monomer is anionically polymerized is discharged; a microchannel forming a flow path connecting the inlet hole and the outlet hole in the main body; a plurality of microchambers arranged in an extension direction of the microchannel and forming an internal space communicating with the flow path; and a collision medium disposed in the internal space to collide with a fluid transferred in the internal space and converting a flow of the fluid in the internal space, and the anionically polymerizing may be performed under a cosolvent of the ether-based solvent and the non-polar solvent.

In the method for manufacturing polymers according to an embodiment, the cosolvent may have a Hansen Solubility Parameter of 16 to 20 MPa^{1/2}.

In the method for manufacturing polymers according to an embodiment, a concentration of the monomer in the first solution may be 1 to 5M.

In the method for manufacturing polymers according to an embodiment, a temperature of the flow path may be −80 to 60 °C.

In the method for manufacturing polymers according to an embodiment, on one plane of the body in in direction in which the flow path extends, the internal space of the microchamber may be formed so that a width thereof gradually increases from the rear to the front based on a flow direction of the fluid, but a front-side connection portion connected to a front-side microchannel is drawn inwardly, and an internal surface of the internal space may be a curved surface.

In the method for manufacturing polymers according to an embodiment, the collision medium may have a length extending in a direction, perpendicular to a flow direction of the fluid on one plane formed by the main body, but may bent backwardly, and the internal space may include: a branch portion in which the fluid collided by the collision medium flows in both directions along both ends of the collision medium in a longitudinal direction; and a confluence portion in which the fluid flowing in both directions of the collision medium flows again in one direction.

In the method for manufacturing polymers according to an embodiment, a diameter L₁ of the flow path formed by the branch portion and a diameter L₂ of the flow path formed by the confluence portion may satisfy the following equation 1,

1<(L₂/L₁)<3 [Equation 1]

In equation 1, L₁ and L₂ are measured along a virtual center line connecting a front-side connection portion connected to a front-side microchannel and a rear-side connection portion connected to a rear-side microchannel, among the microchannels adjacent to the microchamber.

In the method for manufacturing polymers according to an embodiment, an inner diameter R₁ of the flow path formed by the microchannel and a shortest distance D₁ between both ends of the collision medium in a longitudinal direction may satisfy the following equation 2,

3<D₁/R₁<15 [Equation 2]

In the method for manufacturing polymers according to an embodiment, the microchannel may include: an inlet channel connecting the microchamber disposed in a frontmost end in a flow direction of the fluid in the flow path and the inlet hole; a connection channel connecting the microchambers adjacent to each other; and an outlet channel connecting the microchamber disposed in a rearmost end in the flow direction of the fluid in the flow path and the outlet hole.

In the method for manufacturing polymers according to an embodiment, an inner diameter of a flow path at a rear end of at least one channel of the inlet channel and the connection channel gradually may decrease.

In the method for manufacturing polymers according to an embodiment, linear velocity of the fluid may be 0.1 m/s to 1 m/s.

In the method for manufacturing polymers according to an embodiment, the monomer may include an aromatic vinyl monomer.

In the method for manufacturing polymers according to an embodiment, the first solution may be obtained by removing dissolved oxygen.

In the method for manufacturing polymers according to an embodiment, the non-polar solvent includes a C5-C8 alkane-based solvent.

In the method for manufacturing polymers according to an embodiment, the flow path formed by the microchannel may connect the inlet hole and the outlet hole in series, parallel, or series/parallel.

### Advantageous Effects of Invention

The method for manufacturing polymers according to an aspect of the present invention may economically manufacture high-quality polymers having high chemical uniformity.

Additionally, the method for manufacturing polymers according to an aspect of the present invention may perform an anion polymerization reaction even at a relatively high temperature, so that the method may have the advantage of not requiring low-temperature cooling.

Additionally, the method for manufacturing polymers according to an aspect of the present invention may provide an excellent economic advantage by continuously manufacturing a high-quality polymer.

### BRIEF DESCRIPTION OF DRAWINGS

FIG. 1 is a perspective view illustrating a microfluidic reactor according to an embodiment of the present invention;

FIG. 2 is a plan view of the microfluidic reactor illustrated in FIG. 1;

FIG. 3 is a plan view illustrating a microfluidic reactor according to another embodiment of the present invention;

FIG. 4 is a plan view illustrating a microfluidic reactor according to another embodiment of the present invention; and

FIG. 5 is an image illustrating a microfluidic reactor according to an embodiment of the present invention.

### BEST MODE FOR THE INVENTION

In the technical and scientific terms used in the present specification, unless otherwise defined, the terms have the meanings commonly understood by those of ordinary skill in the art to which this disclosure belongs, and descriptions of well-known functions and configurations that may unnecessarily obscure the gist of the present invention in the following description and accompanying drawings will be omitted.

Embodiments of the present invention are provided to more fully explain the present invention to those with average knowledge in the art. Therefore, the scope of the present invention is not limited to the embodiments described below.

The terms used in the description of the present invention are only for the purpose of describing the embodiments of the present invention and should never be limited. Unless clearly used otherwise, a singular form includes a plural form.

The term “include” in the present specification is an open-type description equivalent to expressions such as “comprise,” “contain,” “have,” or “characterizes,” and does not exclude additional elements, materials, or processes that are not listed.

Units used in the present specification without special mention are based on weight, and for example, the unit of % or ratio refers to weight % or weight ratio, and weight % refers to the weight % that any one component of the total composition occupies in the composition, unless otherwise defined.

Additionally, a numerical range used in the present specification includes a lower limit and an upper limit and all values within that range, an increment logically derived from a shape and a width of the defined range, and all possible combinations of double-limited values and the upper limit and the lower limit of a numerical range limited in different forms. Unless otherwise specifically defined in the present specification, values outside the numerical range that may occur due to experimental error or rounding of values are also included in the defined numerical range.

In the present specification, it may be understood that the expressions such as “on,” “above,” “upper,” “below”, “beneath,” “lower,” and “side,” merely indicated based on drawings, and may actually vary depending on the direction in which the elements or components are disposed.

Furthermore, throughout the specification, the terms “connected to” or “coupled to” are used to designate a connection or coupling of one element to another element and include both a case where an element is “directly connected or coupled to” another element and a case where an element is “indirectly connected or coupled to” another element via still another element.

In this specification, the term “polymer” refers to a polymer compound formed by polymerizing a monomer and with a weight average molecular weight of 1,000 or more, and includes not only a single polymer manufactured by polymerizing one monomer but also a copolymer manufactured by polymerizing two or more monomers.

In this specification, the present invention has been described in detail through each aspect and embodiment of the present invention, and each embodiment described in the specification does not mean only one embodiment but also means a combination with other embodiments. Accordingly, the citation of the claims in the scope of the patent claims is only one example and the technical idea of the present invention should not be interpreted only as a combination with the cited claims, and includes and various combinations with the claims are also included in the scope of the technical idea of the present invention.

When an anionic polymerization initiator and a monomer are injected into a reactor, anionic polymerization reaction through a conventional flow-type reaction system may lead to a problem that a molecular weight polydispersity of the polymers manufactured may increase, as the anionic polymerization initiator and the monomer react immediately before the anionic polymerization initiator and the monomer are mixed sufficiently homogeneously.

Additionally, as the polymerization reaction should be performed at cryogenic temperatures in the anionic polymerization reaction through a conventional microfluidic reactor, the energy consumption of cooling facilities may significantly increase to make it significantly uneconomical.

According to one aspect of the present invention, a method for manufacturing polymers includes: (S1) an operation of injecting a first solution containing one or more solvents selected from the group consisting of an ether-based solvent and a non-polar solvent and a monomer, and a second solution containing the one or more solvents selected from the group consisting of the ether-based solvent and the non-polar solvent and an anionic polymerization initiator into a microfluidic reactor; and (S2) an operation of anionically polymerizing the monomer in the microfluidic reactor.

The microfluidic reactor includes: a main body provided with at least one inlet hole through which the first solution and the second solution are introduced, and an outlet hole through which a third solution containing a polymer in which the monomer is anionically polymerized is discharged; a microchannel forming a path connecting the inlet hole and the outlet hole in the main body; a plurality of microchambers arranged along an extension direction of the microchannel and forming an internal space communicating with the path; and a collision medium disposed in the internal space to collide with a fluid transferred in the internal space and configured to change flow of the fluid in the internal space. In this case, the anionically polymerizing may be performed under a cosolvent of the ether-based solvent and the non-polar solvent.

In the method for manufacturing polymers, since the anionic polymerization is performed under the cosolvent in the microfluidic reactor, the anionic polymerization reaction may be performed even at a relatively high temperature, and high-quality polymers with high chemical uniformity may be manufactured economically. Additionally, the method for manufacturing polymers may continuously manufacture high-quality polymers, thereby increasing productivity.

Specifically, as fluids, that is, the first solution and the second solution, are injected and transferred through the flow path in the microfluidic reactor, the monomer and the anionic polymerization initiator are mixed and reacted under the cosolvent. In this case, the fluids may collide with the collision medium, and turbulence may be formed in the flow of the fluids, so that the fluids may be homogeneously mixed. Accordingly, the method for manufacturing polymers may perform anionic polymerization reaction even at a relatively high temperature because the fluids are homogeneously mixed under the cosolvent.

According to an embodiment, the anionic polymerization reaction may be performed when the temperature of the flow path in the microfluidic reactor is −70 to 60 °C, −50 to 60 °C, −40 to 60 °C, −30 to 50 °C, −20 to 50 °C, −10 to 50 °C, 0 to 40 °C or 20 to 40 °C. Accordingly, the method for manufacturing polymers does not require an ultra-low temperature cooling facility requiring excessive power consumption, thereby manufacturing a high-quality polymer with higher economic efficiency. Additionally, the method for manufacturing polymers may efficiently mass-produce high-quality polymers having high chemical uniformity. Furthermore, polymers having a target molecular weight may be easily manufactured, and the molecular weight polydispersity of the manufactured polymers may be improved. Specifically, the molecular weight polydispersity may be controlled to be 1.5 or less, 1.4 or less, 1.3 or less, 1.2 or less or 1.1 or less.

The fluid refers to a material having fluidic properties capable of flowing, and refers to all materials that flow in the microfluidic reactor. Specifically, the fluid may refer to each of the first solution, the second solution and the third solution, or may refer to mixtures of at least two of the first solution, the second solution and the third solution. As a specific example, the fluid before the first solution and the second solution are mixed together in a front side of the microfluidic reactor adjacent to the inlet hole may refer to each of the first solution or the second solution, and the fluid after the first solution and the second solution are mixed in the microfluidic reactor may refer to a mixture of the first solution and the second solution and a third solution which is a reactant thereof. Additionally, the fluid in a rear side of the microfluidic reactor adjacent to the outlet hole may refer to the third solution.

Linear velocity of the fluid in the microfluidic reactor may be appropriately adjusted depending on the type and properties of target polymers.

According to an embodiment, the method for manufacturing polymers changes the linear velocity of the fluid in each position as the diameter of the flow path is repeatedly changed by the microchannel and the microchamber. Accordingly, the linear velocity of the fluid in the microfluidic reactor may vary at each position of the microfluidic reactor even if the fluid is injected at the same flow rate. Specifically, the linear velocity is the rapidest in a connection channel having relatively the smallest flow path cross-sectional area, and is the slowest in the microchamber having the widest flow path cross-sectional area.

According to an embodiment, the linear velocity of the fluid in a microchannel (an inlet channel described below) connecting microchambers adjacent to the inlet hole or a microchannel (an outlet channel described below) connecting microchambers adjacent to the outlet hole may be 0.1 to 1.5 m/s, 0.1 to 1 m/s, 0.1 to 0.9 m/s, 0.2 to 0.8 m/s, or, non-limitingly, 0.2 to 0.7 m/s. As the linear velocity of the fluid satisfies the range described above, turbulence due to collision with the collision medium in the microfluidic reactor may be smoothly formed, but the formation of a dead zone in which the fluid does not flow or the flow rate is rapidly reduced may be prevented. Accordingly, the fluid may be homogeneously mixed throughout the entire flow path region in the microfluidic reactor, thereby manufacturing a higher quality polymer.

The linear velocity of the fluid may be an average value calculated after measuring linear velocity one or more times.

The operation (S1) is an operation of injecting the first solution and the second solution into the microfluidic reactor, and through the operation (S1), the type and flow rate of the first solution and the second solution may be adjusted according to the type and properties of the target polymer and may be injected into the microfluidic reactor. As a specific example, regardless of an internal capacity of the microfluidic reactor, the flow rate of the first solution and the second solution may be adjusted so that the fluid in the microfluidic reactor may maintain the linear velocity. The size of an external injection flow path connected to the microfluidic reactor may be appropriately adjusted according to the internal capacity of the microfluidic reactor.

The internal capacity (volume) of the microfluidic reactor refers to the amount of solution that the microfluidic reactor may accommodate, and may refer to a volume formed by the flow path in the microfluidic reactor, e.g., a flow path formed by the microchannel and the microchamber, and an internal space thereof. The internal capacity of the microfluidic reactor is not particularly limited, and the flow rates of the first solution and the second solution injected in operation S1) may be controlled in proportion to the internal capacity of the microfluidic reactor.

The internal capacity of the microfluidic reactor may be adjusted according to the diameter and length of the flow path in the microfluidic reactor and the size of the internal space of the microchamber. Alternatively, the internal capacity of the microfluidic reactor may be adjusted according to the number of microfluidic reactors that are interconnected. Specifically, the internal capacity of the microfluidic reactor may be increased in proportion to the diameter and length of the flow path in the microfluidic reactor, the size of the internal space of the microchamber, and the number of connected microfluidic reactors, and in proportion thereto, the flow rates of the first solution and the second solution injected in operation (S1) may be adjusted.

As a non-limiting example, when a diameter of an external injection path connecting the microfluidic reactor and a storage tank in which the first solution is stored is ⅛ to ¼ inch, and when a plurality of microfluidic reactors are connected and the internal capacity of the microfluidic reactor is 60 to 100 Ml in total, in operation (S1), the first solution containing the monomer may be injected at a flow rate of 70 to 150 mL/min, 80 to 130 mL/min, or 80 to 120 mL/min, and the second solution containing the anionic polymerization initiator may be injected at a flow rate of 20 to 80 mL/min, 30 to 70 mL/min, or 40 to 60 mL/min, but the present invention is not limited thereto.

In another example, when the diameter of the external injection path connecting the microfluidic reactor and the storage tank in which the first solution is stored is 1 to ⅓ inches, and when the plurality of microfluidic reactors are connected and the internal capacity of the microfluidic reactor is 2000 to 2200 Ml in total, in operation (S1), the first solution containing the monomer may be injected at a flow rate of 2800 to 6000 mL/min, 3200 to 5200 mL/min, or 3600 to 4000 mL/min, and the second solution containing the anionic polymerization initiator may be injected at a flow rate of 800 to 3200 mL/min, 1200 to 2800 mL/min, or 1600 to 2400 mL/min, but the present invention is not limited thereto.

In other words, operation (S1) may be adjusted so that the residence time of the fluid is 5 seconds or more, 10 seconds or more, 15 seconds or more, or 20 seconds or more, regardless of the internal capacity of the microfluidic reactor, and non-limitingly, the flow rate may be adjusted so that the retention time is 60 seconds or less. Specifically, in operation (S1), the flow rate, i.e., the flow rates of the first solution and the second solution may be adjusted so that the residence time of the fluid in the microfluidic reactor is 5 to 60 seconds, 10 to 55 seconds, or 15 to 50 seconds. In the range, a more homogeneous polymer may be manufactured.

The first solution includes at least one solvent selected from the group consisting of an ether-based solvent and a non-polar solvent, and a monomer, as described above. Specifically, the first solution may be formed by including a monomer in the ether-based solvent, or by including the monomer in a non-polar solvent. Alternatively, the cosolvent of the ether-based solvent and the non-polar solvent may include a monomer.

According to an embodiment, the cosolvent of the ether-based solvent and the non-polar solvent may have a Hansen Solubility Parameter of 16 to 20, 17 to 19, 18 to 19, or 18.1 to 18.7. The cosolvent may allow for more uniform mixing of the fluid, and may increase an anionic polymerization reaction temperature. Additionally, even after the anionic polymerization reaction, the flow rate of the fluid may be satisfied in the above-described range, so that it may be possible to manufacture polymers having a further improved molecular weight polydispersity.

The Hansen solubility parameter (S_{co}) may be calculated by the following equation.

S_{co}(MPa^{1/2})=(S₁×W₁)+(S₂×W₂) [Equation]

In the equation, S₁ is a Hansen solubility parameter of an ether-based solvent, W₁ is wt % of the ether-based solvent in the cosolvent, S₂ is a Hansen solubility parameter of a non-polar solvent, and W₁ is wt % of the non-polar solvent in the cosolvent.

In this case, the Hansen solubility parameter of each solvent is a known Hansen solubility parameter (based on 25 °C, for example, a value known through Charles Hansen, “Hansen Solubility Parameters: A User's Handbook” CRC Press (2007)).

In operation (S1), the concentration of the monomer of the first solution may be appropriately adjusted depending on the type of monomer. However, according to an embodiment, the concentration of the first solution may be 1 to 5M, 1 to 4M, 1 to 3M or 2 to 3M, but the present invention is not limited thereto. The first solution having the concentration in the above-described range has an appropriate viscosity for fluid transport, and may be smoothly injected into the microfluidic reactor in operation (S1).

The ether-based solvent included in the first solution may be an aliphatic aprotic ether-based solvent or an alicyclic aprotic ether-based solvent. Specific examples thereof may include diethyl ether, 1,3-dioxolane, 1,2-dimethoxyethane, tetrahydrofuran (THF), 3,5-dimethyl isoxazole, 1,4-dioxane, 4-methyl-1,3-dioxolane, tetraethylene glycol dimethyl ether (TEGDME), diisopropyl ether, or 1,2-diethoxyethane, and mixed solvents thereof, but the present invention is not limited thereto.

The non-polar solvent may specifically be a non-polar hydrocarbon solvent. More specifically, the non-polar solvent may be an aromatic hydrocarbon solvent or an aliphatic hydrocarbon solvent, and more specifically, the aliphatic hydrocarbon solvent may be a C5-C8 alkane solvent. As a non-limiting example, the non-polar solvent may be at least one selected from the group consisting of benzene, toluene, butane, pentane, neopentane, hexane, cyclohexane, methyl cyclohexane, heptane, and octane. As a specific example, the non-polar solvent may be a mixed solvent of hexane and heptane. The monomer may be a styrene monomer, an acrylate monomer, an olefin monomer, or a vinyl monomer, but is not limited to a specific monomer.

According to an embodiment, the monomer may include an aromatic vinyl monomer. Specifically, the aromatic vinyl monomer may be styrene, or a C1-C6 alkoxy styrene, and may be, more specifically, a C1-C4 alkoxy styrene.

An alkoxy-substituted styrene monomer is known to have a slower anionic polymerization rate than unsubstituted styrene. That is, since the alkoxy group substituted on the phenyl group of styrene has the property of an electron-donating group, the polymerization reaction by insertion of the monomer into a living terminal in which polymerization takes place are not quickly performed. Additionally, the alkoxy-substituted styrene monomer is slow in the polymerization initiation reaction due to complex formation with a metal ion. For the same reason as described above, an overall polymerization reaction rate of the alkoxy-substituted styrene monomer in the anionic polymerization reaction is known to be about 10 times lower than that of the styrene monomer. On the other hand, the delayed polymerization initiation reaction may provide an advantage in that the polymerization reaction is not induced immediately when the monomer and initiator solution are mixed, but polymerization may be initiated simultaneously after being uniformly mixed in at least one microchamber. Specifically, in a microfluidic reactor in which the linear velocity of the fluid is low and turbulence is not formed, the aforementioned effect may exhibit excellent effects in terms of reliability and economy of operation. Meanwhile, the polymerization initiation reaction may be further delayed by including the non-polar solvent.

The second solution includes at least one solvent selected from the group consisting of the above-described ether-based solvent and non-polar solvent, and an anionic polymerization initiator. Specifically, the second solution may be formed by including the anionic polymerization initiator in the ether-based solvent, or by including the anionic polymerization initiator in the non-polar solvent. Alternatively, the anionic polymerization initiator may be included in the cosolvent of the ether-based solvent and the non-polar solvent.

However, in order for the anionic polymerization to be performed under the cosolvent of the ether-based solvent and the non-polar solvent, the solvent of the first solution and the solvent of the second solution may both be cosolvents, or may include at least one or more different solvents. As a non-limiting example, when the solvent of the first solution is the ether-based solvent, the solvent of the second solution may be a non-polar solvent or a cosolvent of the ether-based solvent and the non-polar solvent. Additionally, when the solvent of the first solution is the cosolvent, the solvent of the second solution may be the ether-based solvent or the non-polar solvent, or the solvent of the second solution may also be a cosolvent.

The anionic polymerization initiator may include an organometallic compound. The organometallic compound may be an organoalkali metal compound, and may be, for example, ethyllithium, n-butyllithium, sec-butyllithium, t-butyllithium, lithium biphenyl, lithium naphthalene, 1,1-diphenylhexyllithium, 1,1-diphenyl-3-methylpentyllithium, 1,4-dilithio-2-butene, 1,6-dilithiohexane, or the like, but the present invention is not limited thereto. Specifically, the initiator may be one or combinations of two or more selected from the group consisting of n-butyllithium, sec-butyllithium, and t-butyllithium.

According to an embodiment, the concentration of the second solution may be 0.01 to 0.5 M, 0.01 to 0.25 M, 0.02 to 0.2 M, or 0.05 to 0.2 M, but the present invention is not limited thereto. The second solution having the concentration in the above-described range may have an appropriate viscosity for transferring the fluid, and may be smoothly injected into the microfluidic reactor in operation (S1).

According to an embodiment, the first solution and the second solution may be obtained by removing dissolved oxygen. The removal of dissolved oxygen may be performed by injecting nitrogen or argon gas into the storage tank in which the solution is stored. In this manner, the first solution and the second solution from which the dissolved oxygen is removed may have the effect of suppressing the side reaction due to cavitation caused by collision of fluids during anionic polymerization in the microfluidic reactor.

Operation (S2) is an operation of anionically polymerizing the monomer in the microfluidic reactor, which is an operation in which the first solution and the second solution injected into the microfluidic reactor through operation (S1) are mixed and reacted to manufacture the third solution including a polymer. In operation (S2), the monomer is anionically polymerized by the anionic polymerization initiator to manufacture a polymer.

The third solution may refer to both a mixture of the first solution and the second solution and a reactant thereof. Specifically, the third solution may include the cosolvent, a product (polymer) resulting from the anionic polymerization reaction, an unreacted product, an intermediate product, and a side reaction product.

The polymer may be a homopolymer, a random copolymer, or a block copolymer. The random or block copolymer may be a copolymer of two or more monomers, and for example, in the case in which the random or block copolymer is a copolymer of three or more monomers, this may be a ternary random copolymer in which three monomers are uniformly present in a polymer chain. For another example, when three monomers of different types are sequentially injected into the microfluidic reactor and then an anionic polymerization initiator is injected thereinto, a triblock copolymer may be formed. Meanwhile, when two monomers of the three monomers are mixed in advance in the microfluidic reactor without the anionic polymerization initiator injection and an anionic polymerization initiator is then injected thereinto, and then a last monomer is injected, a diblock copolymer having a (M1M2)n(M3)m structure may be manufactured. The type and properties of the polymers manufactured in this manner may be controlled depending on the order of injection of the first and second solutions and the type and number of monomers included in the first and second solutions.

According to an aspect of the present invention, the polymers may control the properties of the polymers through one or more of the following means or combinations of two or more thereof.
(1) Controlling the residence time of the monomer and the anionic polymerization initiator
(2) Controlling the flow rate of the fluid in the microfluidic reactor
(3) The number and connection structure of the microchambers
(4) The temperature of the microchamber

An increase in the flow rate is closely related to the residence time, and the flow rate or the residence time may be controlled to secure the reaction time required to achieve the target conversion rate. Meanwhile, when the reaction time is sufficient, as the flow rate increases, the mixing effect may increase.

Additionally, the shape and length of an entire flow path through which the fluid moves in the microfluidic reactor may be adjusted through the number of microchambers in the microfluidic reactor and a connection structure thereof, which may also be related to the residence time. The number of the microchambers may be 10 to 50, 15 to 40, or 20 to 30, and the microchambers may be connected in series, in parallel, or in series-parallel. The number of microchambers may be increased as the flow rate increases.

The temperature inside the microchamber may be appropriately adjusted by circulating a known cooling medium. The cooling medium may be cooled through a cooler, and the cooled cooling medium may be in contact with an external wall of the microchamber to adjust a temperature of the fluid flowing through an internal wall of the microchamber, and may remove heat generated by an exothermic reaction. The temperature inside the microchamber may be controlled to be −80 to 60 °C, −50 to 60 °C, −40 to 60 °C, −30 to 50 °C, −20 to 50 °C, −10 to 50 °C, 0 to 40 °C, or 20 to 40 °C.

A method for manufacturing polymers according to an aspect of the present invention may further include, after operation (S2), operation (S3) of injecting a polymerization terminator into a microfluidic reactor. The polymerization terminator may include a proton-donating compound such as methanol, a halogenide such as methyl iodide, or other electrophilic substances, but the present invention is not limited thereto. The anionic polymerization reaction may be terminated through operation (S3).

According to an aspect of the present invention, the method for manufacturing polymers may satisfy one or more of the following conditions.

Condition 1. The flow rate of the first solution is greater than the flow rate of the second solution.

Condition 2. The residence time of the fluid in the microfluidic reactor is 10 to 50 seconds.

Condition 3. The ratio of an inlet rate (Qᵢₙ, Ml/min) in the microfluidic reactor and a total length of the flow path (Lₜₒₜₐₗ, cm) to a minimum cross-sectional area (Aₘᵢₙ, cm²) of a flow path in the microfluidic reactor satisfies the following relational expression 1.

7 cm²/min≤Log(Qᵢₙ×(Lₜₒₜₐₗ/Aₘᵢₙ))<9 cm²/min [Relational expression 1]

In the condition 3, the inlet rate (Qᵢₙ) refers the sum (Q₁+Q₂) of a flow rate of the first solution (Q₁) and a flow rate of the second solution (Q₂), a minimum cross-sectional area of the flow path (Aₘᵢₙ) refers to the cross-sectional area in a diameter direction of the connection channel, and a total length of the flow path refers to a value obtained by dividing the internal capacity of the microfluidic reactor by the cross-sectional area of the connection channel.

Specifically, in Condition 1, the ratio (Q₁/Q₂) of the flow rate (Q₁) of the first solution and the flow rate (Q₂) of the second solution may be greater than 1 and 5 or less, greater than 1 and 4 or less, or greater than 1 and 3 or less, and Condition 2, the residence time may be 18 to 45 seconds or 20 to 43 seconds, and in condition 3, the Log(Qᵢₙ×(Lₜₒₜₐₗ/Aₘᵢₙ)) of Relationship Expression 1 may be 7.2 cm²/min to 8.8 cm²/min, 7.5 cm²/min to 8.6 cm²/min, 7.6 cm²/min to 8.5 cm²/min, or 7.7 cm²/min to 8.4 cm²/min.

Non-limitingly, the method for manufacturing polymers may satisfy all of Conditions 1 to 3, and the method for manufacturing polymers may manufacture a more homogeneous polymer.

The microfluidic reactor refers to a device used to obtain a product through chemical reaction synthesis of one or more fluids passing through micrometers or microchannels having sizes equal to or larger than those of the micrometers. Specifically, according to an embodiment of the present invention, the effect aimed at by the present invention may be realized using the microfluidic reactor.

Hereinafter, a microfluidic reactor according to an embodiment of the present invention will be described in detail with reference to the drawings, but the present invention is not limited thereto.

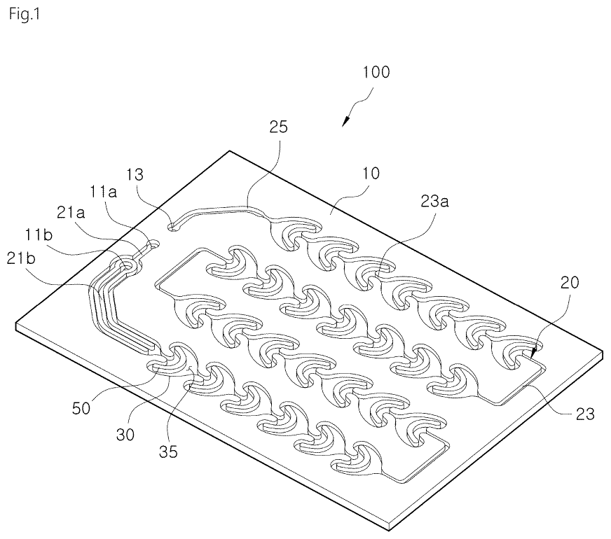

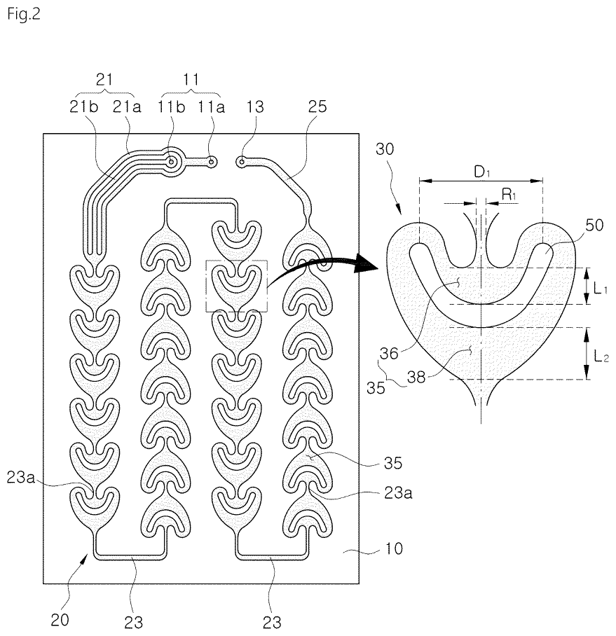

FIGS. 1 and 2 illustrate a microfluidic reactor according to an embodiment of the present invention. For convenience of explanation, the drawings illustrate the microfluidic reactor as having a structure in which an upper portion thereof is open, but actually, the microfluidic reactor may have a structure in which an upper portion (upper surface) thereof is closed.

Referring to FIGS. 1 and 2, the microfluidic reactor according to the present invention includes a main body 10 in which an inlet hole 11 and an outlet hole 13 are formed, a microchannel 20, a microchamber 30, and a collision medium 50.

The main body 10 is a medium in which the microchannel 20, the microchamber 30, and the collision medium 50 are formed, and provides a flow path through which the first to third solutions move and a reaction space in which an anionic polymerization reaction occurs. The main body 10 may be formed of a material that is easy to mold and has high corrosion resistance, non-combustibility and chemical durability. Specifically, the main body 10 may be formed of a metal, ceramic, plastic, or a composite material thereof.

As illustrated in the drawing, the main body 10 may be a plate-shaped structure forming one plane, and the main body 10 may be formed by extending a flow path by a microchannel 20 to be described below in a plane direction of the plate-shaped structure therein. At least one inlet hole 11 is formed in the main body 10 so that the first solution and the second solution may be injected therein, and an outlet hole 13 through which the third solution may be discharged to the outside is formed.

As illustrated in the drawings, the inlet hole 11 may include a first inlet hole 11a and a second inlet hole 11b into which the first solution and the second solution may be injected, respectively, but the present invention is not limited thereto, and may be provided as a single inlet hole or may be provided with three or more inlet holes. That is, the inlet hole 11 may be appropriately adjusted according to the type and number of solutions required for manufacturing the polymers desired to be manufactured.

The inlet hole 11 and the outlet hole 13 of the main body 10 may be connected to the flow rate control system so that the flow rate and the flow velocity may be appropriately adjusted.

Unlike illustrated in the drawings, a separate plate member (not illustrated) may be bonded to an upper surface of the main body 10 to close the flow path with respect to an upper portion of the main body 10.

As illustrated in the drawings, the inlet hole 11 and the outlet hole 13 may be formed in a position adjacent to an edge of the main body 10 provided as a planar structure, and unlike this, the inlet hole 11 and the outlet hole 13 may be formed in a center portion of the main body 10 or a portion adjacent thereto.

The microchannel 20 forms a flow path in the main body 10, and a flow path connecting the inlet hole 11 and the outlet hole 13 is formed on one plane formed by the main body 10. A shape of the flow path formed by the microchannels 20 is not particularly limited. For example, as illustrated in the drawings, a flow path configured for meandering may be formed one plane formed by the main body 10. The microchannel 20 may integrate a flow path in the main body 10, thereby making a reaction system more compact.

The microchannel 20 according to an aspect of the present invention may include an inlet channel 21 configured to connect the microchamber 30 disposed in a frontmost end in a flow direction of the fluid in the flow path and the inlet hole 11, a connection channel 23 connecting the microchambers 30 adjacent to each other, and an outlet channel 25 configured to connect the microchamber 30 disposed in a rearmost end in the flow direction of the fluid in the flow path and the outlet hole 13.

In this case, the flow direction of the fluid refers to the macroscopic flow of the fluid from the inlet hole 11 to the outlet hole 13. The microscopic flow of the fluid converted by the collision medium 50, that is, the flow of turbulence is ignored. Based on the flow direction of the fluid, a side at the inlet hole 11 of the microfluidic reactor may be classified into a front side (or front end) and a side at the outlet hole 13 may be classified into a rear side (or rear end).

However, as the microchannel 20 forms a meandering flow path on the body 10, assuming that any one microchamber 30 and a microchamber 30 connected thereto in a straight line are microchamber arrays, the microchamber arrays adjacent to each other may appear to have fluid moving in opposite directions.

As a plurality of inlet holes 11 are provided, a plurality of inlet channels 21 may be provided to correspond thereto. As a specific example, when the main body 10 includes the first inlet hole 11 and the second inlet hole 11, as illustrated in the drawings, the inlet channel 21 may include a first inlet channel 21a extending from the first inlet hole 11 and a second inlet channel 21b extending from the second inlet hole 11. In this case, the first and second inlet channels 21a and 21b may communicate with each other in a front end of the microchamber 30 disposed in a foremost position.

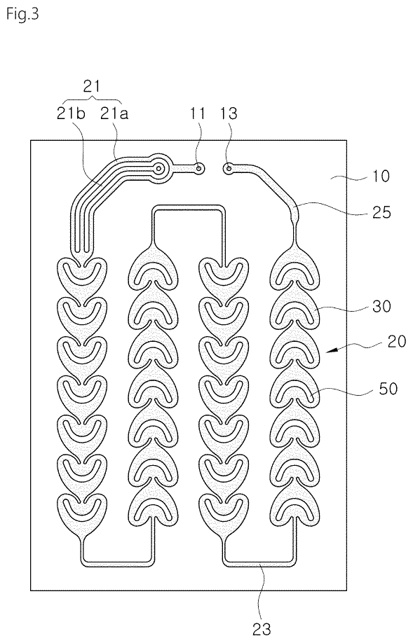

The connection channel 23 forms a flow path connecting the microchambers 30, and may include a main connection channel 23 connecting microchamber arrays adjacent to each other and a sub-connection channel 23a connecting each microchamber 30 in the microchamber array. As illustrated in FIGS. 1 and 2, the main connection channel 23 and the sub-connection channel 23a may be provided at the same time, but unlike this, as illustrated in FIG. 3, each of the microchamber 30 may be directly connected thereto without the sub-connection channel 23a.

The outlet channel 25 forms a flow path connecting the microchamber 30 disposed in the rearmost end and the outlet hole 13, and may allow the fluid passing through the microchambers 30 to be discharged to the outside of the main body 10 through the outlet hole 13.

In the microchannel 20 according an aspect of the present invention, at least one of the inlet channels 21 and the connection channels 23 may gradually decrease an inner diameter of a flow path on the rear end. That is, the rear end of the inlet channel 21 or the connection channel 23 may have a tapered shape in which a width of the flow path becomes gradually narrower. The fluid may be transferred by increasing the flow rate of the fluid to the microchamber 30 connected to the inlet channel 21 or the connection channel 23. Accordingly, it may be possible to continuously induce remarkably excellent mixing and homogeneous reactions by supplying fluid to the adjacent microchamber 30 at a high flow rate.

A plurality of the microchamber 30 are arranged along the flow path and forms an internal space 35 communicating with the flow path formed by the microchannel 20. The internal space 35 is a transfer path through which the fluid is transferred, and at the same time, the internal space 35 may be a mixing space in which the fluid may be sufficiently mixed by the collision medium 50.

The internal space 35 of the microchamber 30 according to an aspect of the present invention may have a shape in which a width thereof gradually increases from the rear to the front, based on the flow direction of the fluid, on one plane of the main body 10 in the direction in which the flow path extends, but a front-side connection portion connected to a front-side microchannel 20 is drawn inwardly. In this case, an inner surface of the internal space 35 may be a curved surface. In other words, the internal space 35 of the microchamber 30 may be a circle distorted in one direction, i.e., a heart shape, as illustrated in the drawing. The internal space 35 of the microchamber 30 in this manner may allow the fluid to flow smoothly along the inner surface of the internal space 35 even if the fluid is collided by the collision medium 50 to change the flow of the fluid. That is, although the collision medium 50 causes turbulence in the fluid in the internal space 35, the turbulence does not obstruct the flow of the fluid from the inlet hole 11 to the outlet hole 13, so that continuous manufacturing of the polymer may be performed smoothly.

The collision medium 50 is disposed in the internal space 35 of the microchamber 30, and is an obstacle to the fluid flow in the microchamber 30. The collision medium 50 is not particularly limited as long as this has a structure that may cause a collision with the fluid flowing in the microchamber 30 to form turbulence in the internal space 35. According to an embodiment, the collision medium 50 has a length extending in a direction, perpendicular to the flow direction of the fluid on a plane formed by the main body 10, but is bent backwardly. However, both ends of the collision medium 50 in a longitudinal direction do not contact an inner surface of the microchamber 30.

In this case, the internal space 35 may include a branch portion 36 in which the fluid collided by the collision medium 50 flows in both directions along both ends of the collision medium 50 in the longitudinal direction, and a confluence portion 38 in which the fluid flowing in both directions of the collision medium 50 flows in one direction again. The internal space 35 and the collision medium 50 may cause the fluid to collide firstly and be homogeneously mixed by the collision medium 50, and after the first-collided fluid passes through the branch portion 36, the fluids may face each other in the confluence portion 38 and may collide each other secondly to induce further uniform mixing and reaction. This may maximize the turbulence formation of the fluid, but may maintain the flow rate of the fluid uniformly, thereby inducing excellent mixing and homogeneous reaction of the fluid more smoothly.

The internal space 35 may satisfy the following equation 1 in a diameter L₁ of a flow path formed by the branch portion 36 and a diameter L₂ of a flow path formed by the confluence portion 38.

1<(L₂/L₁)<3 [Equation 1]

In Equation 1, L₁ and L₂ are measured along a virtual center line connecting the front-side connection portion connected to the front-side microchannel 20 and a rear-side connection portion connected to a rear-side microchannel 20, among the microchannels 20 adjacent to the microchamber 30. Specifically, L₂/L₁ may be 1.1 to 2.8, 1.2 to 2.5, or 1.5 to 2.3. Accordingly, the fluid may be transferred at a high flow rate and more homogeneously mixed when transferred from the branch portion 36 to the confluence portion 38.

A length of the collision medium 50 is not particularly limited as long as the collision medium 50 does not contact the inner surface of the microchamber 30 as described above. However, in an embodiment, an inner diameter R₁ of the flow path formed by the microchannel 20 and the shortest distance D₁ between both ends of the collision medium 50 in the longitudinal direction may satisfy the following Equation 2.

3<D₁/R₁<15 [Equation 2]

Specifically, D₁/R₁ may be 4 to 13, 5 to 12, or 6 to 10. Accordingly, the fluid flowing into the microchamber 30 from the microchannel 20 may collide more strongly with the collision medium 50, thereby inducing significantly excellent mixing and homogeneous reaction.

According to an embodiment, the flow paths formed by the microchannels 20 may be connected in series, parallel, or series-parallel between the inlet hole 11 and the outlet hole 13.

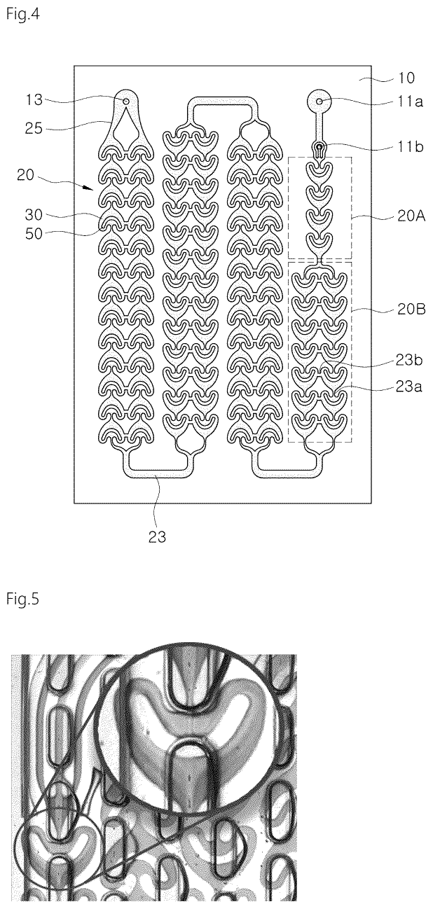

FIG. 4 illustrates a microfluidic reactor in which the inlet hole 11 and the outlet hole 13 are connected in series and in parallel. In the microfluidic reactor, since the flow paths are formed in series and in parallel, the microchambers 30 arranged in communication with the flow paths may also be connected in series and parallel to each other. The microchannel 20 may include a series connection portion 20A in which the flow paths are connected in series and a parallel connection portion 20B in which the flow paths are connected in parallel. As illustrated in the drawing, the microchambers disposed in the parallel connection portion 20B may be disposed in parallel to each other. In this case, the microchambers 30 that are parallel to each other may be connected to each other through a parallel connection channel 23b. The microfluidic reactor may react a larger amount of fluid, thereby enabling more mass production.

According to an embodiment, the microfluidic reactors are connected to each other in series in multiple numbers, so that each microfluidic reactor may be driven as one reactor module. Accordingly, each microfluidic reactor may be controlled with different flow rates, residence times, and temperatures.

Hereinafter, the present invention will be specifically described through examples. However, it should be noted that the examples described below are only intended to illustrate and concretize the present invention, and are not intended to limit the scope of the rights of the present invention. This is because the scope of the rights of the present invention is determined by the matters described in the patent claims and matters able to be reasonably inferred therefrom.

### Inventive Examples 1 to 18

The polymers were manufactured by anionic polymerization through the microfluidic reactor (Module size: 162×188.5×21 (mm)) illustrated in FIG. 5. An internal volume of the microfluidic reactor was controlled by the number of connected microfluidic reactors, and the internal volume (capacity) for each example is listed in Table 1 below.

4-tert-butoxy styrene in which a concentration thereof was adjusted by a solvent and oxygen was removed through argon bubbling, was injected as the first solution into the first inlet hole, and n-butyllithium (n-BuLi) in which a concentration thereof was adjusted by the solvent and oxygen was removed through argon bubbling, was injected as the second solution into the second inlet hole. The concentrations of the first and second solutions and the solvents used for each example are listed in Table 1 below.

Then, a polymerization terminator with a concentration of 1M (solvent: tetrahydrofuran (THF)) was injected into the first inlet hole. The polymerization terminators used for each example are listed in Table 1 below.

The first solution, the second solution, and the polymerization terminator were injected through a ⅛ inch tube, and the injection flow rates of the first solution, the second solution and the polymerization terminator for each example, the temperature of the flow path in the microfluidic reactor, and the residence time of the fluid in the microfluidic reactor are listed in Table 2 below. Additionally, R (relationship between the flow rate, the flow path cross-sectional area, and the flow path length) calculated from the following relational expression 2 is listed in Table 2.

R(cm²/min)=Log(Qᵢₙ×(Lₜₒₜₐₗ/Aₘᵢₙ)) [Relational Expression 2]

In Relational Expression 1, Qᵢₙ refers to an inlet flow rate (Mg/min) in the microfluidic reactor, i.e., the sum (Q₁+Q₂) of the flow rate (Q₁) of the first solution and the flow rate (Q₂) of the second solution, and Aₘᵢₙ refers to a minimum cross-sectional area (cm²) of the flow path in the microfluidic reactor, i.e., a cross-sectional area in a diametric direction of the connection channel, and Lₜₒₜₐₗ refers to a total length (cm) of the flow path, i.e., the internal capacity (volume) of the microfluidic reactor divided by the cross-sectional area of the connection channel.

During the polymerization, a temperature of the flow path in the microfluidic reactor was adjusted through a temperature control unit (TCU System) connected to the microfluidic reactor, and the total flow rate was measured in the outlet channel disposed in the rearmost end of the microfluidic reactor.

TABLE 1

| | | Type | | | | |
|---|---|---|---|---|---|---|
| | | | | | | Third |
| | | | | | | Solution |
| | | First Solution | | Second Solution | | Polymeri- |
| | | Concen- | Sol- | Concen- | | zation |
| Division | V(ml) | tration | vent | tration | Solvent | terminator |
| Inventive | 60 | 2M | THF | 0.05M | n- | Ethanol |
| Example 1 | | | | | heptane | |
| Inventive | 60 | 1.5M | THF | 0.05M | n- | Ethanol |
| Example 2 | | | | | heptane | |
| Inventive | 60 | 2M | THF | 0.05M | n- | Methanol |
| Example 3 | | | | | heptane | |
| Inventive | 60 | 2M | THF | 0.03M | n- | Ethanol |
| Example 4 | | | | | heptane | |
| Inventive | 60 | 2M | THF | 0.1M | n- | Ethanol |
| Example 5 | | | | | heptane | |
| Inventive | 60 | 2M | THF | 0.05M | n- | Isopropanol |
| Example 6 | | | | | heptane | |
| Inventive | 60 | 1M | THF | 0.02M | n- | Methanol |
| Example 7 | | | | | heptane | |
| Inventive | 60 | 1M | THF | 0.05M | n- | Ethanol |
| Example 8 | | | | | heptane | |
| Inventive | 60 | 2M | DIPE | 0.05M | n- | Ethanol |
| Example 9 | | | | | heptane | |
| Inventive | 60 | 2M | THF | 0.05M | toluene | Ethanol |
| Example | | | | | | |
| 10 | | | | | | |
| Inventive | 40 | 2M | THF | 0.05M | n- | Ethanol |
| Example | | | | | heptane | |
| 11 | | | | | | |
| Inventive | 80 | 2M | THF | 0.05M | n- | Isopropanol |
| Example | | | | | heptane | |
| 12 | | | | | | |
| Inventive | 60 | 2.5M | THF | 0.02M | n- | Ethanol |
| Example | | | | | heptane | |
| 13 | | | | | | |
| Inventive | 100 | 2M | THF | 0.05M | n- | Methanol |
| Example | | | | | heptane | |
| 14 | | | | | | |
| Inventive | 60 | 2M | THF | 0.05M | n- | Methanol |
| Example | | | | | heptane | |
| 15 | | | | | | |
| Inventive | 60 | 2M | THF | 0.05M | n- | Ethanol |
| Example | | | | | heptane | |
| 16 | | | | | | |
| Inventive | 20 | 2M | THF | 0.05M | n- | Methanol |
| Example | | | | | heptane | |
| 17 | | | | | | |
| Inventive | 120 | 2M | THF | 0.05M | n- | Isopropanol |
| Example | | | | | heptane | |
| 18 | | | | | | |

V: Internal Volume of Microfluidic Reactor
THF: Tetrahydrofuran
DIPE: Diisopropyl ether

TABLE 2

| | Flow Rate(ml/min) | | | | Temper- | Resi- | |
|---|---|---|---|---|---|---|---|
| | First | Second | Third | Total | ature | dence | R |
| | Solu- | Solu- | Solu- | Flow | of Reactor | Time | (cm²/ |
| Division | tion | tion | tion | Rate | (°C) | (s) | min) |
| Inventive | 116 | 41 | 19 | 176 | 0 | 22.93 | 8.18 |
| Example 1 | | | | | | | |
| Inventive | 98 | 57 | 18 | 173 | 0 | 23.23 | 8.18 |
| Example 2 | | | | | | | |
| Inventive | 86 | 60 | 17 | 163 | 0 | 24.66 | 8.15 |
| Example 3 | | | | | | | |
| Inventive | 82 | 62 | 15 | 159 | 0 | 25.00 | 8.15 |
| Example 4 | | | | | | | |
| Inventive | 81 | 68 | 19 | 168 | 0 | 24.16 | 8.16 |
| Example 5 | | | | | | | |
| Inventive | 106 | 48 | 19 | 173 | 30 | 23.38 | 8.18 |
| Example 6 | | | | | | | |
| Inventive | 119 | 42 | 10 | 171 | 0 | 22.36 | 8.20 |
| Example 7 | | | | | | | |
| Inventive | 120 | 58 | 17 | 195 | 0 | 20.22 | 8.24 |
| Example 8 | | | | | | | |
| Inventive | 113 | 39 | 18 | 170 | 0 | 23.68 | 8.17 |
| Example 9 | | | | | | | |
| Inventive | 106 | 48 | 19 | 173 | 0 | 23.38 | 8.18 |
| Example 10 | | | | | | | |
| Inventive | 82 | 37 | 15 | 134 | 0 | 20.17 | 7.89 |
| Example 11 | | | | | | | |
| Inventive | 118 | 58 | 15 | 191 | 0 | 27.27 | 8.36 |
| Example 12 | | | | | | | |
| Inventive | 75 | 72 | 20 | 167 | 0 | 24.49 | 8.16 |
| Example 13 | | | | | | | |
| Inventive | 80 | 60 | 10 | 150 | 0 | 42.86 | 8.36 |
| Example 14 | | | | | | | |
| Inventive | 43 | 20 | 8 | 71 | 0 | 57.14 | 7.79 |
| Example 15 | | | | | | | |
| Inventive | 38 | 112 | 20 | 170 | 0 | 24.00 | 8.16 |
| Example 16 | | | | | | | |
| Inventive | 98 | 44 | 18 | 160 | 0 | 8.45 | 7.66 |
| Example 17 | | | | | | | |
| Inventive | 109 | 59 | 20 | 188 | 0 | 42.80 | 8.51 |
| Example 18 | | | | | | | |

### Comparative Examples 1 TO 8

In the examples, the polymers were manufactured in the same manner as in the inventive examples, except that the polymers were manufactured using a PFA tube (inner diameter ⅛ inch, Perfluoroalkoxy alkanes tube/Swagelok) instead of the microfluidic reactor. The total volume of the flow path in the PFA tube for each comparative example, the solvent and concentration of the first and second solutions, and the polymerization terminator for the third solution are listed in Table 3 below, and the input flow rates of the first solution, the second solution, and the polymerization terminator for each comparative example, the temperature of the flow path in the microfluidic reactor, and the residence time of the fluid in the microfluidic reactor are listed in Table 4 below.

TABLE 3

| | | Type | | | | |
|---|---|---|---|---|---|---|
| | | | | | | Third |
| | | | | | | Solution |
| | | First Solution | | Second Solution | | Polymeri- |
| | | Concen- | Sol- | Concen- | Sol- | zation |
| Division | V(ml) | tration | vent | tration | vent | terminator |
| Comparative | 60 | 2M | THF | 0.05M | n- | Ethanol |
| Example 1 | | | | | heptane | |
| Comparative | 60 | 1M | THF | 0.05M | n- | Ethanol |
| Example 2 | | | | | heptane | |
| Comparative | 120 | 2M | THF | 0.05M | n- | Methanol |
| Example 3 | | | | | heptane | |
| Comparative | 60 | 2M | THF | 0.1M | n- | Ethanol |
| Example 4 | | | | | heptane | |
| Comparative | 60 | 2M | THF | 0.05M | n- | Isopropanol |
| Example 5 | | | | | heptane | |
| Comparative | 60 | 2M | THF | 0.05M | n- | Ethanol |
| Example 6 | | | | | heptane | |
| Comparative | 60 | 2M | THF | 0.05M | THF | Ethanol |
| Example 7 | | | | | | |
| Comparative | 60 | 1M | THF | 0.1M | n- | Isopropanol |
| Example 8 | | | | | heptane | |

V: Internal Volume of PFA Tube
THF: Tetrahydrofuran
DIPE: Diisopropyl ether

TABLE 4

| | Flow Rate (ml/min) | | | | | Resi- |
|---|---|---|---|---|---|---|
| | | | | Total | Temperature | dence |
| | First | Second | Third | Flow | of Reactor | Time |
| | Solution | Solution | Solution | Rate | (°C) | (s) |
| Comparative | 106 | 48 | 19 | 173 | 0 | 23.38 |
| Example 1 | | | | | | |
| Comparative | 120 | 58 | 18 | 196 | 0 | 20.22 |
| Example 2 | | | | | | |
| Comparative | 90 | 40 | 17 | 147 | 0 | 55.38 |
| Example 3 | | | | | | |
| Comparative | 82 | 57 | 15 | 154 | 0 | 25.90 |
| Example 4 | | | | | | |
| Comparative | 106 | 48 | 19 | 173 | 10 | 23.38 |
| Example 5 | | | | | | |
| Comparative | 106 | 48 | 19 | 173 | 30 | 23.38 |
| Example 6 | | | | | | |
| Comparative | 106 | 48 | 19 | 173 | 0 | 23.38 |
| Example 7 | | | | | | |
| Comparative | 82 | 60 | 20 | 162 | 0 | 25.35 |
| Example 8 | | | | | | |

### <Polymer Evaluation>

### 1) Conversion Rate (%)

The conversion rate of the polymer manufactured using the following Equation 1 is calculated and shown in Table 5 below.

Conversion Rate(%)=((number of moles of tert-butoxy styrene reacted)/(number of moles of tert-butoxy styrene added))×100 [Equation 1]

### 2) Molecular Weight, Polydispersity

The number average molecular weight (Mn) and polydispersity (PDI) of the polymers manufactured in the Examples and Comparative Examples were measured using Gel Permeation Chromatography (GPC) from Waters. The columns used Shodex KF-801, KF-802, KF-803 and KF-804, the standard sample used Shodex polystyrene, and the solvent used tetrahydrofuran, and the temperature was 40 °C, and the flow rate was 1.0 mL/min. The results are shown in Table 5 below.

### 3) Side Reaction

In the case of a polymerization reaction including p-alkoxystyrene as a monomer, for example, p-methoxystyrene, it is known that the polymerization initiation reaction is significantly slow and the termination reaction proceeds quickly (J. Polym. Sci. Part A-1 1969, 7, vol 7, pages 2859 to 2873). The occurrence of the termination reaction may be easily confirmed through the color change of the polymerization solution, and a polymer with a wide PDI may be manufactured by a rapid termination reaction, or even an insoluble precipitate may occur due to a crosslinking reaction by ring metalation.

In order to determine whether a side reaction occurred in the method for manufacturing polymers according to the inventive examples and comparative examples, the color change of the fluid in the reactor was observed with the naked eye. When the reaction proceeds properly without a side reaction, the fluid in the reactor exhibits a unique color close to red and orange, but if the side reaction occurs, the unique color is lost and the color changes to transparent. Based thereon, the color of the fluid in the reactor was observed to determine whether there was a side reaction, and the results are shown in Table 5 below. If the side reaction occurred, it was marked with “o,” and if no side reaction occurred, it was marked with “x.”

TABLE 5

| | Characteristics | | | |
|---|---|---|---|---|
| | Conversion | | | Side |
| Division | Rate [%] | Mn | PDI | Reaction |
| Inventive Example 1 | 100 | 9,716 | 1.043 | x |
| Inventive Example 2 | 100 | 5,673 | 1.051 | x |
| Inventive Example 3 | 100 | 6,306 | 1.063 | x |
| Inventive Example 4 | 100 | 9,698 | 1.091 | x |
| Inventive Example 5 | 100 | 2,620 | 1.058 | x |
| Inventive Example 6 | 88 | 10,267 | 1.182 | o |
| Inventive Example 7 | 100 | 15,583 | 1.074 | x |
| Inventive Example 8 | 100 | 4,551 | 1.053 | x |
| Inventive Example 9 | 100 | 12,748 | 1.066 | x |
| Inventive Example 10 | 100 | 9,716 | 1.061 | x |
| Inventive Example 11 | 100 | 9,751 | 1.077 | x |
| Inventive Example 12 | 100 | 7,161 | 1.065 | x |
| Inventive Example 13 | 99 | 5,179 | 1.072 | x |
| Inventive Example 14 | 100 | 5,366 | 1.085 | x |
| Inventive Example 15 | 100 | 9,832 | 1.286 | o |
| Inventive Example 16 | 100 | 1,692 | 1.192 | o |
| Inventive Example 17 | 40 | 2,157 | 1.062 | x |
| Inventive Example 18 | 100 | 17,354 | 1.482 | o |
| Comparative Example 1 | 87 | 11,224 | 1.225 | o |
| Comparative Example 2 | 90 | 6,551 | 1.211 | o |
| Comparative Example 3 | 100 | 11,254 | 1.334 | o |
| Comparative Example 4 | 97 | 4,164 | 1.342 | o |
| Comparative Example 5 | 92 | 9,330 | 1.229 | o |
| Comparative Example 6 | 72 | 11,380 | 1.421 | o |
| Comparative Example 7 | 96 | 13,422 | 1.292 | o |
| Comparative Example 8 | 98 | 2,903 | 1.379 | o |

Referring to Table 5 above, it was confirmed that the polymer manufactured according to the examples had a PDI closer to 1 than the comparative examples and that a homogeneous polymers were able to be manufactured. Additionally, it was confirmed that the polymer manufactured from the examples had a low molecular weight of about 5000 in number average molecular weight as compared to the comparative examples. Additionally, it was confirmed that most of the examples had a conversion rate of 100% and that no side reaction occurred.

1. A method for manufacturing polymers, comprising:
(S1) an operation of injecting a first solution containing one or more solvents selected from the group consisting of an ether-based solvent and a non-polar solvent and a monomer, and a second solution containing the solvent and an anionic polymerization initiator into a microfluidic reactor; and
(S2) an operation of anionically polymerizing the monomer in the microfluidic reactor,
wherein the microfluidic reactor comprises:
a main body provided with at least one inlet hole through which the first solution and the second solution are introduced and an outlet hole through which a third solution containing a polymer in which the monomer is anionically polymerized is discharged;
a microchannel forming a flow path connecting the inlet hole and the outlet hole in the main body;
a plurality of microchambers arranged in an extension direction of the microchannel and forming an internal space communicating with the flow path; and
a collision medium disposed in the internal space to collide with a fluid transferred in the internal space and converting a flow of the fluid in the internal space, and
wherein the anionically polymerizing is performed under a cosolvent of the ether-based solvent and the non-polar solvent.

2. The method for manufacturing polymers according to claim 1, wherein the cosolvent has a Hansen Solubility Parameter of 16 to 20 MPa^{1/2}.

3. The method for manufacturing polymers according to claim 1, wherein a concentration of the monomer in the first solution is 1 to 5M.

4. The method for manufacturing polymers according to claim 1, wherein a temperature of the flow path is −80 to 60 °C.

5. The method for manufacturing polymers according to claim 1, wherein on one plane of the body in a direction in which the flow path extends;
the internal space of the microchamber is formed so that a width thereof gradually increases from the rear to the front based on a flow direction of the fluid, but a front-side connection portion connected to a front-side microchannel is drawn inwardly, and
an internal surface of the internal space is a curved surface.

6. The method for manufacturing polymers according to claim 1, wherein the collision medium has a length extending in a direction, perpendicular to a flow direction of the fluid on one plane formed by the main body, but is bent backwardly, and
the internal space includes:
a branch portion in which the fluid collided by the collision medium flows in both directions along both ends of the collision medium in a longitudinal direction; and
a confluence portion in which the fluid flowing in both directions of the collision medium flows again in one direction.

7. The method for manufacturing polymers according to claim 6, wherein a diameter L₁ of the flow path formed by the branch portion and a diameter L₂ of the flow path formed by the confluence portion satisfy the following equation 1,
1<(L₂/L₁)<3 [Equation 1]
where L₁ and L₂ are measured along a virtual center line connecting a front-side connection portion connected to a front-side microchannel and a rear-side connection portion connected to a rear-side microchannel, among the microchannels adjacent to the microchamber.

8. The method for manufacturing polymers according to claim 6, wherein an inner diameter R₁ of the flow path formed by the microchannel and a shortest distance D₁ between both ends of the collision medium in a longitudinal direction satisfy the following equation 2,
3<D₁/R₁<15. [Equation 2]

9. The method for manufacturing polymers according to claim 1, wherein the microchannel includes:
an inlet channel connecting the microchamber disposed in a frontmost end in a flow direction of the fluid in the flow path and the inlet hole;
a connection channel connecting the microchambers adjacent to each other; and
an outlet channel connecting the microchamber disposed in a rearmost end in the flow direction of the fluid in the flow path and the outlet hole.

10. The method for manufacturing polymers according to claim 9, wherein an inner diameter of a flow path at a rear end of at least one channel of the inlet channel and the connection channel gradually decreases.

11. The method for manufacturing polymers according to claim 1, wherein linear velocity of the fluid is 0.1 m/s to 1 m/s.

12. The method for manufacturing polymers according to claim 1, wherein the monomer includes an aromatic vinyl monomer.

13. The method for manufacturing polymers according to claim 1, wherein the first solution is obtained by removing dissolved oxygen.

14. The method for manufacturing polymers according to claim 1, wherein the non-polar solvent includes a C5-C8 alkane-based solvent.

15. The method for manufacturing polymers according to claim 1, wherein the flow path formed by the microchannel connects the inlet hole and the outlet hole in series, parallel, or series/parallel.
